(19) United States
(12) Patent Application Publication
(10) Pub. No.: US 2016/0167564 A1
(43) Pub. Date: Jun. 16, 2016

(54) DEVICE FOR FIXING A LIGHTING AND/OR SIGNALING MODULE TO A STRUCTURAL ELEMENT

(71) Applicant: VALEO VISION, Bobigny Cedex (FR)

(72) Inventors: Remi Letoumelin, Chessy (FR); Cyril Dubuc, Champs sur Marne (FR)

(21) Appl. No.: 14/908,856

(22) PCT Filed: Jul. 28, 2014
(86) PCT No.: PCT/EP2014/066151

§ 371 Date: Jan. 29, 2016

(30) Foreign Application Priority Data
Aug. 2, 2013 (FR) 1357699

(51) Int. Cl. B60Q 1/068; F21S 8/10; F16B 25/00

(52) U.S. Cl. CPC B60Q 1/0683; F16B 25/0068; F21S 48/211; F21S 48/1113; F21S 48/1104

(57) ABSTRACT

A device for fixing a lighting and/or signaling module to a structural element, including a screw assembly adapted to adjust the distance between the lighting and/or signaling module and the structural element. The screw assembly includes a screw adapted to cooperate with two nuts via two distinct screw threads, a first nut being fastened to the structural element and a second nut being fastened to the lighting and/or signaling module. The distinct screw threads have specific threads in that they are all oriented in the same direction, the threads of a first screw thread have a different pitch than the threads of the second screw thread. For one turn of the screw, the rotation of the screw generates a movement of the lighting and/or signaling module relative to the structural element that is equal to the difference between the pitches of the threads of the two screw threads.

The present invention concerns a lighting and/or signaling assembly including a module fixed to a structural element fastened to the bodywork of a motor vehicle. It more particularly concerns the device for fixing this lighting and/or signaling module to the structural element.

A module classically includes a housing inside which are disposed the light source and the associated reflection means for appropriately orienting the light ray leaving the module. The housing of the module includes fixing tabs adapted to cooperate with screw means for fixing the position of the housing of the module relative to the bodywork of the vehicle, notably by means of a structural element that also includes fixing holes. Thus the module is assembled to the structural element, or if the optical requirements necessitate a plurality of modules the modules are assembled to the structural element, and the assembly is thereafter fixed to the bodywork of the motor vehicle.

The various regulations that motor vehicle manufacturers must comply with notably require a very accurate direction of the light beams leaving the lighting and/or signaling module in accordance with the required traffic and lighting conditions. The increasingly frequent use of light-emitting diodes is leading to multi-module architectures necessitating systems for precise alignment of each module so that the exit beam is oriented in such a manner as to comply with the regulations.

Now, adjustment screws having a very fine pitch are screws of small diameter and are therefore fragile. There is the risk of them not being able to absorb all of the forces that the module may be subjected to when mounting the lighting and/or signaling assembly or the vibrations caused when the vehicle is moving.

Moreover, regardless of the diameter of the adjustment screw used, the automated tightening tools used on production lines are programmed to perform portions of a turn, for example quarter-turns. This industrial constraint, necessary for optimum efficiency of the manufacturing process, is difficult to make compatible with the high accuracy required for positioning one part relative to the other.

The present invention aims to propose a device for fixing a lighting and/or signaling module to a structural element of a motor vehicle that allows a very fine adjustment pitch for optimizing the position of this module without weakening the fixing of said module.

In this context, the invention proposes a device for fixing a lighting and/or signaling module to a structural element, including a screw assembly adapted to adjust the orientation of the module relative to the structural element, for example the distance from the module to the structural element. The screw assembly includes a screw adapted to cooperate with two nuts via two distinct screwthreads, a first nut being fastened to the structural element and a second nut being fastened to the module. The distinct screwthreads have specific threads in that they are all oriented in the same direction and in that the threads of a first screwthread have a different pitch than the threads of the second screwthread. For one turn of the screw, the rotation of the screw generates a movement of the module relative to the structural element that is equal to the difference between the pitches of the threads of the two screwthreads.

Relative movements of the module and the structural element toward or away from each other that are very small can therefore be produced so that, for a given quarter-turn adjustment, movements are produced that are as accurate as those that could be produced with a screw of very small diameter. The benefit of producing this accurate adjustment with a stronger screw that ensures increased stability over time of the initial adjustment of the position of the module is very clear.

The difference between the pitches of the threads of the two screwthreads is advantageously less than 0.4 mm per turn.

In accordance with one feature of the invention, the two nuts are stacked axially so that the screw carries the two screwthreads. The screw includes a shank having two parts with different diameters, each of the parts having on its external surface one of the screwthreads.

In accordance with various features, the two nuts may be arranged around the screw shank without the two nuts being in contact, the first nut having a hole through it whereas the second nut includes a blind hole, or the first nut is extended axially to cover the second nut so that it is this first nut that carries the means for preventing rotation of the second nut.

More generally, the invention also concerns a lighting and/or signaling assembly including a fixing device as described above, characterized in that the first nut and the structural element carry complementary means for preventing movement in translation and in rotation relative to each other and the second nut and the module carry complementary means for preventing movement in translation and in rotation relative to each other.

In accordance with various features of the invention:

the first nut includes a flange that projects from the external surface of the first nut and two diametrically opposite lugs disposed on said external surface at an axial distance from the flange substantially equal to the thickness of the structural element;

a compressible annular seal is disposed axially between the flange and the lugs, said annular seal being notably adapted to be pressed against a lateral wall of the flange;

the structural element includes circular holes adapted to have the adjustable fixing devices passed through them and around which means forming a guide and locking ramp are provided for fastening the first nut relative to the structural element in a bayonet-type fixing;

the means forming the guide and locking ramp, which project from the structural element, include two diametrically opposite ramp paths each having an inclined plane shape in which a housing is formed to receive a lug, said ramp paths being symmetrically separated by cut-outs in the wall delimiting the edge of the hole at the entry of the ramp paths so as to form clearances for the passage of the lugs of the nuts;

the second nut includes a spherical head at the closed end of the second nut and two diametrically opposite lugs arranged on the external surface of the second nut so as to extend axially along it;

the head has a substantially spherical shape that a finger extends axially on the side opposite the second nut;

the lugs of the second nut are aligned with the lugs of the first nut when the nuts are disposed on the screw shank;

the module includes fixing plates formed by a vertical plate with a hole at its centre forming a cavity adapted to receive the spherical head of the second nut and four tabs projecting from the plate, said four tabs being grouped in pairs to form two guide paths for the lugs of the second nut in the axial direction thereof;

the module and the structural element are assembled by means of three fixing areas including a forcible fixing area forming a reference point for the adjustment of the distance between the module and the structural element by two adjustable fixing devices, one being used for a horizontal adjustment whereas the other is used for a vertical adjustment;

a fixing plate is associated with the adjustable fixing device for the vertical adjustment so that the path formed between the tabs guides a lug of the second nut axially and vertically and prevents horizontal movement perpendicular to the axis of the screw and wherein a fixing plate is associated with the adjustable fixing device for the horizontal adjustment so that the path formed between the tabs guides a lug of the second nut horizontally and prevents vertical movement.

The invention also concerns a motor vehicle including a lighting and/or signaling assembly in which the structural element is adapted to carry a plurality of modules. This assembly is particularly suitable for providing the vehicle with adaptive beam lighting and means for controlling the plurality of light sources associated with the lighting modules, because the invention enables very accurate positioning of the modules relative to the structural element and therefore of the modules relative to one another, which is an imperative condition for hardware beam lighting.

The invention and the advantages that stem from it are described in detail in the following nonlimiting detailed description with reference to the appended drawings, in which:

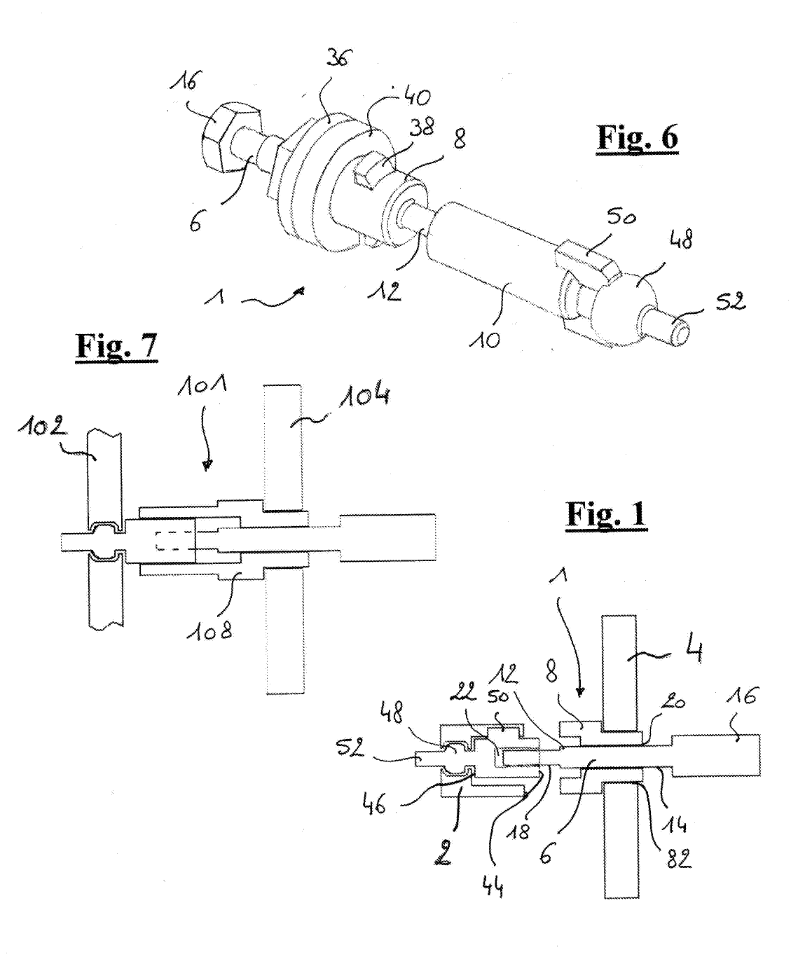

FIG. 1 is a diagram showing in section the device in accordance with the invention for fixing a lighting module relative to a structural element, both shown in part;

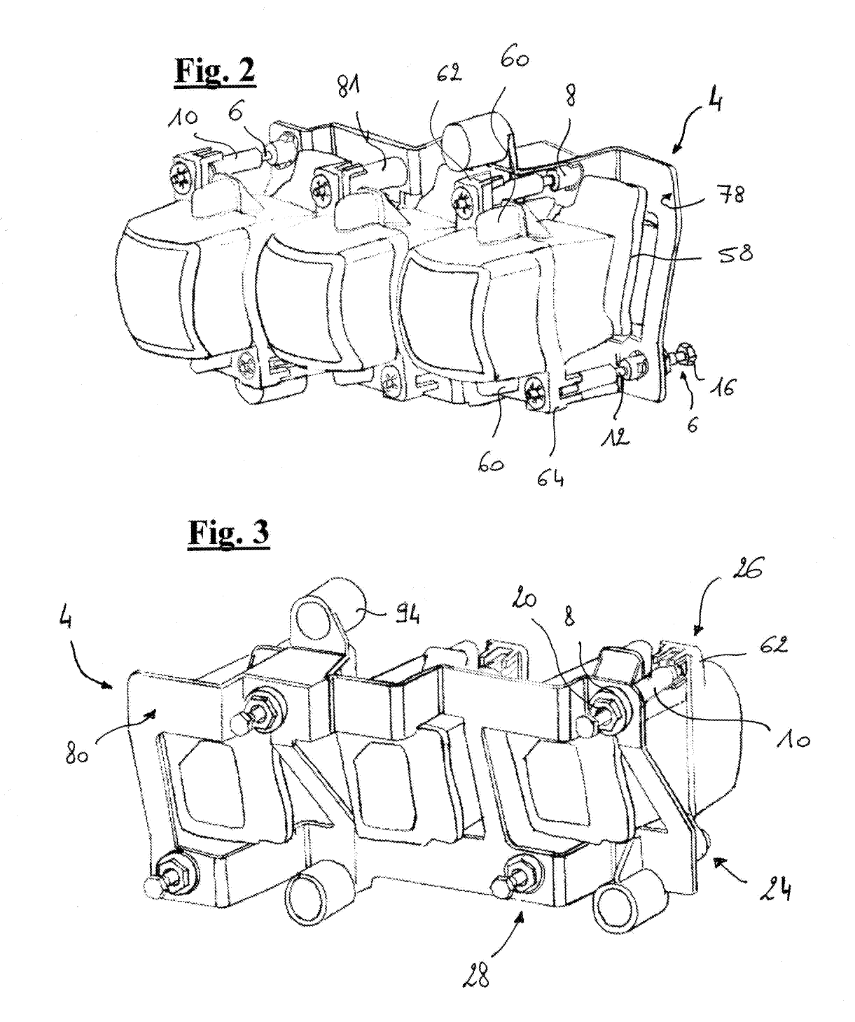

FIGS. 2 and 3 are perspective views from the front and from the rear, respectively, of a lighting and/or signaling assembly in which three modules are fixed to a structural assembly, notably by means of the fixing devices shown in FIG. 1;

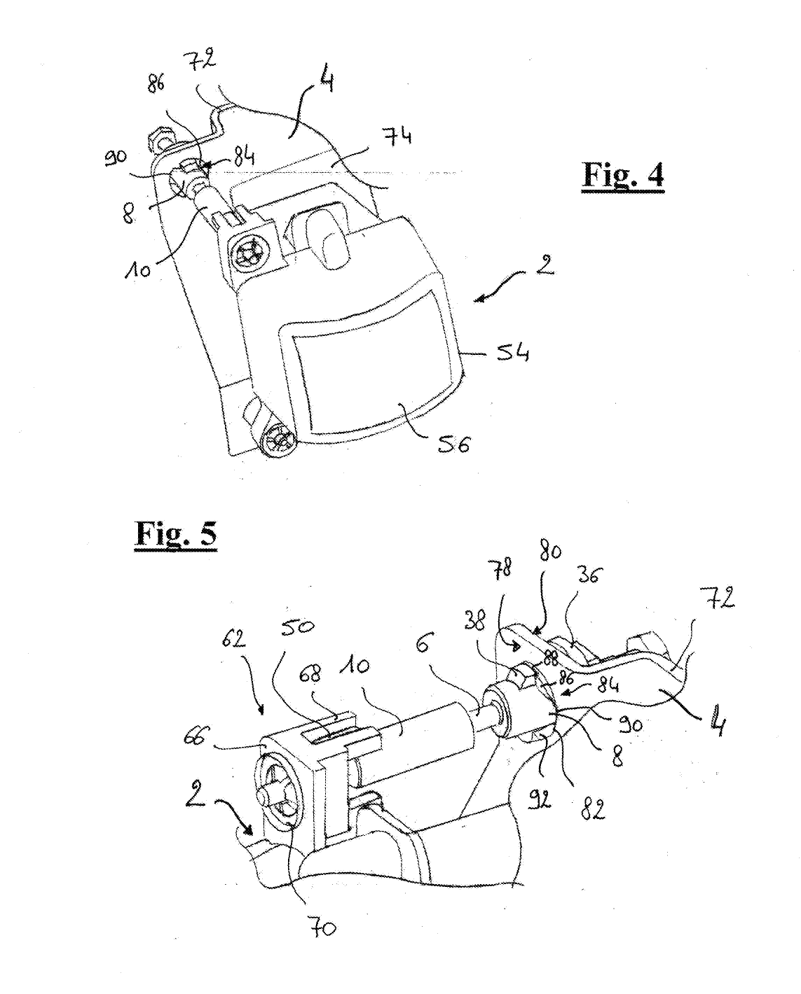

FIG. 4 is a detail view of one of the modules shown in FIGS. 2 and 3;

FIG. 5 is a detail view of one of the fixing devices in accordance with the invention associated with the module shown in FIG. 4, more particularly the fixing device enabling vertical adjustment of the fixing of the module relative to the structural assembly;

FIG. 6 is a perspective view of the fixing device alone, as shown in FIGS. 2 to 5; and

FIG. 7 is a diagram showing a second embodiment of the fixing device in accordance with the invention in an orientation similar to that of the FIG. 1 diagram.

As shown in FIG. 1, a device in accordance with the invention enables the fixing of a lighting module 2 to a structural element 4. The fixing device primarily includes a screw assembly formed of a screw 6 and two nuts 8 and 10, one of which is connected to the lighting module and the other of which is connected to the structural element.

Here the two nuts are stacked axially, i.e. are disposed along the axis of the screw. To this end, the screw shank 12 has along its axis two distinct parts with different diameters. A proximal part 14 of the shank continuous with the screwhead 16 has a greater diameter than a distal part 18 of the shank at the free end of the latter.

The proximal part of the shank has on its external surface a first external screwthread the threads of which, oriented in a certain direction, have a particular pitch. The distal part of the shank has on its external surface a second external screwthread, the threads of which have a pitch different from that of the first screwthread, being oriented in the same direction as the threads of the first screwthread.

A first nut 8 is disposed around the greater diameter proximal part of the shank and a second nut 10 is disposed around the lesser diameter distal part of the shank. The first nut is tapped on the internal face of a central hole 20 with the direction and the pitch of the threads adapted to cooperate with the first screwthread of the screw. Similarly, the second nut is tapped on the internal face of a central hole 22 with the direction and the pitch of the threads adapted to cooperate with the second screwthread of the screw.

The first nut 8 is fastened to the structural element 4 and the second nut 10 is fastened to the lighting and/or signaling module 2. There is described hereinafter, during the detail description of one of the various embodiments, how one and the other of the nuts are fastened to the structural element and to the module. Generally speaking, there are available at the level of each of the nuts axial stop means and rotation blocking means, so as to fix the position of the nuts relative to the structural element and the module, respectively, when the screw turns, so that a movement in translation of the screw relative to the nuts is generated, this relative movement being transmitted to the structural element and to the module because of the axial stop means.

The operating principle of such a fixing device is as follows. The position of the structural element relative to the module is adjusted by screwing the clamping screw inside the two nuts respectively constrained to move with the module and with the structural element. Because in accordance with the invention it has two screwthreads with slightly different pitches but in the same direction, the screw advantageously enables movement of the structural element relative to the module that is smaller, for one turn of the screw, than the value of the pitch of one or other of the screwthreads.

When the screw is tightened, it advances relative to the first nut disposed around the proximal part of the shank and fixed relative to the structural element by the rotation blocking means and axial stop means. The screw therefore advances relative to the structural element and thus tends to move toward the module on being screwed into the second nut disposed around the distal part of the shank. This results in movement of the second nut and the module fastened to it toward the first nut and the structural element. For a given turn of the screw, the screw 6 moves relative to the structural element 4 over a distance equal to the value of the pitch P1 of the external screwthread of the proximal part of the shank. At the same time, it is screwed into the second nut 10 over a distance equal to the value of the pitch P2 of the external screwthread of the distal shank part, so that the second nut and the associated module move toward the structural element. The result of this is that the movement of the module relative to the structural element is equal to the value of the pitch of the screwthread of the proximal part minus the value of the pitch of the screwthread of the distal part (P1−P2).

As shown in FIGS. 2 and 3, this type of fixing is particularly useful if a plurality of modules must be placed on the same structural element. In this type of signaling and/or lighting assembly including a plurality of modules side by side, which is notably applied in motor vehicles, the position of each of the modules relative to the structural element must be very accurate in order for the position of the modules relative to one another to correspond to the specification and so that adaptive beam lighting can be provided, for example. The principle of this type of lighting consists in producing a light beam from a plurality of independent sources of the light-emitting diode type. Depending on the traffic conditions and the identified requirement to illuminate such or such a part of the road, in such or such a manner, each of the light sources is controllable and can be turned off or turned on, possibly with varying degrees of intensity. In order to obtain a homogeneous beam that provides an efficient response to control input, each of the sources must illuminate the area that is assigned to it very accurately, and for this it is necessary that the initial position of the diodes be as accurate as possible and remains reliable over time. The assembly tolerances are therefore extremely small and the use of fixing devices in accordance with the invention for assembling the modules makes it possible to provide very small mounting clearances.

Each module is mounted on the structural element via three fixing means, two of which are adjustable fixing devices in accordance with the invention. A non-adjustable first fixing means 24 offers a fixed point that provides a reference point for the adjustment of the distance between the module and the structural element. The two adjustable fixing devices 26 and 28 are disposed in line with the fixed point, a first one 26 being aligned vertically relative to this fixed point to adjust the vertical position of the assembly while the other one 28 is aligned horizontally relative to this fixed point to adjust the horizontal position of the assembly. As described hereinafter, the two adjustable fixing devices therefore differ in that the rotation blocking means of the second nut allow vertical or horizontal sliding.

The fixing device in accordance with a first embodiment is described next. As has been possible to describe in general terms, the fixing device primarily includes a screw 6 and two nuts 8 and 10, one of which is connected to the lighting module 2 and the other of which is connected to the structural element 4. To illustrate this first embodiment, in which the rotation blocking means of the second nut are notably adapted to cooperate with elements carried by the lighting module, reference is made to FIGS. 2 to 6 and to the FIG. 1 diagram.

The screw includes a hexagonal head 16 so that it is easier for automated tightening means on the production line to hold and a shank 12 that extends axially and has two different diameters. As described above, the proximal part 14 of the shank near the screwhead has a greater diameter than the distal part 18. The proximal part has on its external surface an external screwthread the threads of which are oriented in a certain direction and have a pitch P1. The distal part also has on its external surface an external screwthread the threads of which are oriented in the same direction as those of the screwthread of the proximal part but have a pitch P2 different from the pitch P1. For example, an external screwthread of the proximal part could have a pitch of 0.7 mm per turn and an external screwthread of the distal part a pitch of 0.5 mm per turn. For a given turn of the screw, as explained above, the module moves 0.2 mm toward the structural element. It is particularly beneficial for this relative movement to be less than 0.4 mm although such a value is difficult to obtain with a single guide screw without the latter being too fragile with the risk of the fixing not being durable over time.

The first nut and the second nut are respectively mounted around the screwthread of the proximal part and around the screwthread of the distal part.

The first nut 8 has a cylindrical shape with its axis parallel to the axis of the shank. This first nut has a central hole 20 through it of slightly greater diameter than the proximal part of the shank so that it can be threaded around this shank. The internal face of the bore is tapped with the orientation and the pitch of the threads enabling it to cooperate with the external screwthread on the external surface of the proximal part of the shank.

The first nut moreover includes, on its external surface, means adapted to cooperate with the structural element. A flange 36 projects from the external surface and two diametrically opposite lugs 38 are disposed on the external surface at an axial distance from the flange substantially equal to the thickness of the structural element. A compressible annular seal 40 is further provided, disposed in the axial housing produced between the flange and the lugs, this annular seal being adapted to be pressed against a lateral wall of the flange to improve the sealing of the assembly.

The second nut has a cylindrical shape with its axis parallel to the axis of the shank. Once again, the second nut has a central hole 22 through it of slightly greater diameter than the distal part of the shank so that it can be threaded around the shank. The internal face of the hole is tapped with the orientation and the pitch of the threads enabling it to cooperate with the external screwthread on the external surface of the distal part of the shank. The central hole is a blind hole and thus the second nut has an open end 44 that can be threaded around the screw shank and a closed end 46.

The second nut moreover includes, on its external surface, means adapted to cooperate with the lighting module. A head 48 is disposed at the closed end of the second nut and diametrically opposite lugs 50 are arranged on the external surface so as to extend axially along the second nut. The head has a substantially spherical shape and a finger 52 extends said head axially on the side opposite the second nut.

As can be seen in the figures, the lugs of the second nut are aligned axially with the lugs of the first nut in order to enable the assembly of the assembly, as described in detail hereinafter.

FIGS. 2 to 5 show, at least in part, one or more lighting modules and a structural element adapted to support those modules.

A lighting module 2 includes a housing 54 closed by an outer lens 56 and inside which is disposed a light-emitting diode that cannot be seen in the figures. Cooling means 58 are provided on the back of the housing and various stiffener ribs 60 may be provided on this housing. To enable the module to be fixed to the structural element, the module includes three fixing plates each corresponding to a fixing area of the module. The two fixing plates 62 and 64 associated with the adjustable fixing devices include a vertical plate 66 with a hole at its centre forming a cavity adapted to receive the spherical head of the second nut and four tabs 68 projecting from the plate. These four tabs are grouped in pairs to form two guide paths for guiding the second nut in the axial direction. For the fixing plate 62 associated with said vertical fixing area, which can be seen in FIGS. 4 and 5, the path formed between the tabs guides a lug of the second nut axially and vertically and prevents horizontal movement perpendicular to the axis of the screw. For the fixing plate 64 associated with said horizontal fixing area, which can be seen in FIG. 2, the path formed between the tabs guides a lug of the second nut horizontally and prevents vertical movement.

A rapid fixing washer 70 is pressed against the vertical plate of the fixing plates on the side opposite the guide tabs to grip the finger extending the head of the second nut by means of deformable interior teeth. When the second nut is mounted in the fixing plate of the module, the finger projects beyond the fixing plate and the washer forms means for immobilizing the second nut in this axial position.

The structural element takes the form of a three-dimensional plate 72 including openings 74 for means for cooling the modules to pass through. The plate has a front face 78 facing toward the lighting and/or signaling modules when the assembly is assembled and an opposite rear face 80. The structural element has around the openings a fixed stud 81 for each module that projects axially and the free end of which carries a spherical head substantially equivalent to the head formed at the end of the second nut of the adjustable fixing device. This fixed stud is adapted to be pushed into the fixing plate of the module corresponding to the fixed fixing area.

The plate forming the structural element further includes circular holes 82 for each module adapted to have the adjustable fixing devices passed through them and around which guide and locking ramp forming means 84 are provided for fastening the first nut to the structural element in a bayonet-type fixing. The diameter of the holes is substantially equal to the outside diameters of the nuts, being less than the diameter of the flange projecting from the first nut, so as on the one hand to allow the screw and the second nut to pass through and on the other hand to form an abutment for the flange of the first nut to stop axial insertion of the screw. The ramp forming means project from the front face 78 and include two diametrically opposite ramp paths 86. Each ramp path has an inclined plane that follows the perimeter of the edge delimiting the hole and a housing 88 is formed at the end of the ramp path to receive a lug. In a symmetrical way, cut-outs are produced in the wall delimiting the edge of the hole at the entry of the ramp paths so as to form clearances 90 for the lugs of the nuts to pass through. In fact, the hole, the ramp forming means and the clearances form an assembly adapted for insertion of the fixing device in a “push-turn” manner specific to a bayonet type fixing. The nut can turn only one way, toward the entry of the ramp path, because rotation in the opposite direction is blocked by the presence of an end wall 92 of the other ramp path, forming a shoulder following on from the symmetrical cut-outs in the wall.

The assembly of the assembly formed by the structural element, the lighting and/or signaling module and the fixing devices is described next.

The fixing device is assembled first by mounting the nuts 8 and 10 on the screw 6, matching the correct nut with the corresponding part of the shank. The nuts are threaded from the distal part 18, starting with the first nut 8. Its inside diameter substantially equal to the diameter of the proximal part 14 allows it to move along the smaller diameter distal part without damaging the threads. The first nut is then screwed onto the external screwthread of the proximal part. The second nut 10 is then mounted by screwing it onto the external screwthread of the distal part and the lugs 38 and 50 of the two nuts are aligned axially.

Next the fixing device is assembled to the structural element 4 by means of the first nut. To this end, the fixing device is passed through the hole 82 in the structural element, from behind the structural element, passing the second nut through first. The lugs of the second nut 50 pass through the structural element thanks to the lateral clearances 88 formed on the edge delimiting the hole. Insertion of the fixing device continues until an abutting relationship is produced by contact of the flange 36 and the seal 40 against the rear face 80 of the structural element. The lugs of the first nut 38 are then passed from the other side of the structural element, also being passed through the hole thanks to the same lateral clearances, the lugs of the first nut and those of the second nut being aligned. The first nut is then turned so that the lugs of the first nut 38 mount the ramps 86. The rotation of the first nut, by substantially one quarter-turn, is stopped when the lugs take up their place in the housing 90 produced in the ramp path. In this housing, the lug is no longer pressed against the front face 76 of the structural element, which causes the flange to move toward the rear face and compression of the seal between the structural element and the flange. The flange and the lugs of the first nut form axial stop means axially trapping the structural element, while the housings on the ramp path and the lugs of the first nut form rotation blocking means. These blocking means enable conversion of the rotation movement of the screw into a movement in translation of the first nut and the axial stop means make it possible to fasten together the first nut and the structural element for axial movement when the first nut moves in translation because of the rotation of the screw.

Once this first nut has been immobilized relative to the structural element, the assembly formed by the structural element and the fixing device is mounted on the module 2 by fixing the second nut to this module.

Beforehand the module and the structural element are forcibly connected by causing the spherical head of the fixed stud 81 to cooperate with the corresponding fixing plate. The adjustable fixing devices and the module are then connected. To this end, the spherical head 48 of the second nut is clipped into the corresponding fixing plate 62, 64 of the module, guiding this head axially by the cooperation of the lugs of the second nut with the two facing slideways formed between the tabs 68 of the fixing plate of the module. The assembly is fastened together by means of rapid attachment means 70 of the deformable washer type mounted on the face of the fixing plate of the module from which projects the finger axially extending the spherical head of the second nut.

The advance of the module relative to the structural element can then be adjusted by turning the screw to create two axial movements of the two nuts relative to the screw, which generates a movement of the module relative to the structural element that is equal to the difference between the pitches of the distinct external screwthreads carried by the screw, as explained above.

In the case of an application to an automobile vehicle, the assembly is then fixed to the bodywork of the vehicle by screwing at the level of fixing bushings 94 carried by the structural element.

On reading the foregoing description, it is clear that the invention achieves the objects set for it, notably to propose fixing means enabling easy assembly of the lighting and/or signaling assembly with an accuracy increased by the adjustment of the relative movement of the module and the structural element, which relative movement can easily be less than 0.4 mm per turn of the screw.

The fixing device in accordance with the invention moreover makes great accuracy possible at the same time as giving preference to the use of an adjustment screw with the standard diameters, which makes it possible to ensure an adjustment that is stable over time, the screw not being too small and therefore too fragile.

It is clear that these objectives are also achieved in variant embodiments that do not depart from the scope of the invention, and notably in the fixing device in accordance with a second embodiment described next with reference to the FIG. 7 diagram. The same reference numbers as for the fixing device 1 increased by 100 are used for similar elements.

The fixing device 101 is globally similar to the device 1 except that the means for blocking rotation of the second nut are carried by the first nut 108 and not by the lighting and/or signaling module 102.

This results in a different shape of the first nut and the fixing plate carried by the module. The first nut is extended axially to cover the second nut and includes an internal groove adapted to accommodate the lug fastened to the second nut. The nuts are mounted on the screw in an extreme position of mutual assembly of the nuts. Either the nuts are moved as far apart as possible in order to be threaded together onto the screw via the distal part, and the first nut is first screwed onto the external screwthread of the proximal part, or the nuts are as moved close together as possible, i.e. the second nut is entered as far as possible into the first nut, so as to be threaded together onto the screw via the distal part, and the second nut is first screwed onto the distal part.

In fact, the fixing plate has no projecting fixing tabs adapted to guide the lugs of the second nut axially.

The assembly of the fixing device is nevertheless substantially the same, as is assembling it to the module 102 and the structural element 104, and the operation for the fine adjustment of the position of the module relative to the structural element is the same as before.

1. A device for fixing a lighting and/or signaling module to a structural element, comprising a screw assembly adapted to adjust the orientation of said lighting and/or signaling module relative to said structural element, wherein said screw assembly includes a screw adapted to cooperate with a first nut and a second nut via two distinct screw threads, said first nut being fastened to said structural element and said second nut being fastened to said lighting and/or signaling module the said two distinct screw thread having specific threads in that they are all oriented in the same direction and in that the threads of a first screw thread have a different pitch than the threads of a second screwthread.

2. The fixing device as claimed in claim 1, whererin the difference between the pitches of the threads of said two distinct screw threads is less than 0.4 mm per turn.

3. The fixing device as claimed in claim 1, wherein said first and second nuts are stacked axially so that said screw carries said two distirict screw threads.

4. The fixing device as claimed in claim 3, wherein said screw includes a screw shank having two parts with different diameters, each of said two parts having on its external surface one of said two distinct screw threads.

5. The fixing device as claimed in claim 4, wherein said first and second nuts are arranged around said screw shank without said first and second nuts being in contact.

6. The fixing device as claimed in claim 1, wherein said first nut has a hole through it whereas said second nut includes a blind hole.

7. The fixing device as claimed in claim 1, wherein said first nut includes a flange that projects from an external surface of said first nut and at least one lug, notably two diametrically opposite lugs, disposed on said external surface at an axial distance from said flange substantially equal to a thickness of said structural element.

8. The fixing device as claimed in claim 7, wherein said second nut includes a spherical head at a closed end of said second nut and at least one lug, notably two diametrically opposite lugs, arranged on an external surface of said second nut so as to extend axially along it.

9. The fixing device as claimed in claim 8, wherein said spherical head has a substantially spherical shape that a finger extends axially on the side opposite said second nut.

10. The fixing device as claimed in claim 7, wherein said at least one lug of said second nut are is aligned with said at least one lug of said first nut when said first and second nuts are disposed on a screw shank.

11. The fixing device as claimed in claim 3, wherein said first and second nuts are arranged around a screw shank and in that said first nut is extended axially to cover said second nut so that said first nut carries means for preventing rotation of said second nut.

12. A lighting and/or signaling assembly including a lighting and/or signaling module, a structural element and a fixing device according to claim 1 for fixing said lighting and/or signaling module to said structural element.

13. The lighting and/or signaling assembly as claimed in claim 12, wherein said first nut and/or said structural element carry complementary means for preventing movement in translation and in rotation relative to each other and said second nut and/or said lighting and/or signaling module carry complementary means for preventing movement in translation and in rotation relative to each other.

14. The lighting and/or signaling assembly as claimed in claim 13, wherein said first nut includes a flange that projects from the an external surface of said first nut and at least one lug, notably two diametrically opposite lugs, disposed on said external surface at an axial distance from said flange substantially equal to the thickness of said structural element.

15. The lighting and/or signaling assembly as claimed in claim 14, wherein a compressible annular seal is disposed axially between said flanged and said at least one lug, said annular seal notably being adapted to be pressed against a lateral wall of said flange.

16. The lighting and/or signaling assembly as claimed in claim 13, wherein said structural element includes circular holes adapted to have adjustable fixing devices passed through them and around which means forming a guide and a locking ramp are provided for fastening said first nut relative to said structural element, notably in a bayonet-type fixing.

17. The lighting and/or signaling assembly as claimed in claim 16, wherein said means forming said guide and said locking ramp, which project from said structural element, include two diametrically opposite ramp paths each having an inclined plane shape in which a housing is formed to receive a lug, said ramp paths being symmetrically separated by cut-outs in a wall delimiting an edge of said circular holes at an entry of said ramp paths so as to form clearances for the passage of said lugs of said first and second nuts.

18. The lighting and/or signaling assembly as claimed in claim 13, wherein said second nuts includes a spherical head at a closed end of said second nut and at least one lug, notably two diametrically opposite lugs, arranged on an external surface of said second nut so as to extend axially along it.

19. The lighting and/or signaling assembly as claimed in claim 18, wherein said spherical head has a substantially spherical shape that a finger extends axially on a side opposite said second nut.

20. The lighting and/or signaling assembly as claimed in claim 14, wherein said lugs of said second nut are aligned with said lugs of said first nut when said first and second nuts are disposed on a screw shank.

21. The lighting and/or signaling assembly as claimed in claim 18, wherein said lighting and/or signaling module includes fixing plates formed by a vertical plate with a hole at its center forming a cavity adapted to receive said spherical head of said second nut and four tabs projecting from said plate, said four tabs being grouped in pairs to form two guide paths for said lugs of said second nuts in the axial direction thereof.

22. The lighting and/or signaling assembly as claimed in claim 12, wherein said lighting and/or signaling module and said structural element are assembled by means of three fixing areas including a forcible fixing area forming a reference point for the adjustment of the distance between said lighting and/or signaling module and said structural element by two adjustable fixing devices, one being used for a horizontal adjustment whereas the other is used for a vertical adjustment.

23. The lighting and/or signaling assembly as claimed in claim 20, wherein a first fixing plate is associated with one of said two adjustable fixing devices for the vertical adjustment so that the path formed between tabs guides a lug of said second nuts axially and vertically and prevents horizontal movement perpendicular to the axis of said screw and wherein a second fixing plated is associated with one of said two adjustable fixing devices for the horizontal adjustment so that said path formed between said tabs guides said lug of said second nut horizontally and prevents vertical movement.

24. The lighting and/or signaling assembly as claimed in claim 1, wherein said structural element is adapted to carry a plurality of said lighting and/or signaling modules.

25. A motor vehicle including a lighting and/or signaling assembly as claimed in claim 24 and means for controlling an adaptive beam lighting system.
